(19) United States
(12) Patent Application Publication
(10) Pub. No.: US 2007/0267272 A1
(43) Pub. Date: Nov. 22, 2007

(54) Slat

(76) Inventors: Daniel Grant, London (GB); Douglas Grant, London (GB)

Correspondence Address: BLANK ROME LLP, 600 NEW HAMPSHIRE AVENUE, N.W., WASHINGTON, DC, 20037, US

(21) Appl. No.: 10/588,995

(22) PCT Filed: Feb. 11, 2005
(86) PCT No.: PCT/GB05/00467

§ 371 Date: Feb. 20, 2007

(30) Foreign Application Priority Data
Feb. 11, 2004 (GB) 0402998.9

(51) Int. Cl. G09F 19/22

(52) U.S. Cl. 198/502.1; 40/526

(57) ABSTRACT

A slat for inter alia an endless conveyor the slat having a main body (10) part of the upper surface (14) of which is transparent. The slat has a cavity (12) formed underneath the transparent surface in which a removable cartridge carrying advertising can be located such that the advertising can be viewed through the transparent surface of the slat.

The present invention relates to a slat and a method of making a slat. More particularly, but not exclusively, the invention relates to a slat for a conveyor comprising a multiplicity of such slats and more particularly to a slat for a conveyor which is able to display indicia, for example advertising material.

Reference herein to “slat” is used to describe any sheet, panel or the like which provides, for example, one of a multiplicity of cooperating load supporting surfaces for an endless conveyor, e.g. a luggage carousel but also includes moving panels, sheets and the like for use on escalators, or stationary/moving walkways, and other panels for fixed structures such as floor, wall and ceiling panels.

For most travellers, part of the process of travelling by air includes collecting luggage from one of many luggage carousels located within an airport. This involves large numbers of travellers standing alongside one of several conveyor carousels waiting for their luggage to appear. The amount of luggage transported on a particular flight and common-place delays in processing the luggage often result in a traveller waiting alongside a carousel for a significant period of time.

Conventionally, the exposed surfaces of slots of a carousel are plain and carry no data of an informative or advertising nature. Applying a layer of advertising data on one or more slats of a conveyor is known, for example in GB 227858 and WO 93/03472, wherein decorative porcelain enamel or plastic plates are adhered to some or all conveyor slats. Such advertising is, however, permanent due to the nature of the design and consequently, each data-containing slat must be replaced if the advert or design is to be changed. Furthermore, the top surface of each slat is subjected to intense wearing by the luggage placed on, and dragged off, the conveyor and by the neighbouring slats which slide over one another when the conveyor changes direction. In time, such wear will render the data at least partially illegible.

In one embodiment, the present invention sets out to provide a slat for a conveyor that alleviates the problems described above by having a removable cartridge carrying indicia, for example advertising, located therein.

In one aspect, the invention provides a slat for inter alia a conveyor, the slat comprising a main body whose upper surface is at least partially transparent and which includes a cavity positioned below the transparent surface for retaining a removable cartridge.

The term “cartridge” is intended to include any item capable of being inserted into and selectively removable from the cavity.

Preferably the cavity is defined between the upper surface of the main body and a lower surface thereof; the lower surface may be removably or permanently secured to the upper surface.

One or both ends of the cavity may be open to facilitate insertion of a cartridge. Alternatively, the upper and/or lower surface of the main body may include a closable opening through which a cartridge may be inserted into or removed from the slat.

Preferably the upper surface is made from tempered glass or a similarly hard wearing transparent material. The material is preferably flexible and may be provided with a scratch-resistant surface. The lower surface is preferably made from steel or a similar material.

Preferably the cartridge comprises a suitably shaped structure which defines a relatively snug fit within the cavity and has a decorative or plain surface. In the former case, when in use, the cartridge is located within the cavity of the main body of the slat with its decorative surface immediately beneath the transparent part of the upper surface of the main body. The cartridge may be of any desired shape and/or dimensions. Thus the cartridge may comprise a disc, sheet, rectangular or otherwise shaped body of a given thickness.

Preferably the cartridge is held within the main body by friction or semi-permanent adhesion. Alternatively, catches may be provided at one or each open side of the cavity to retain the cartridge in place. Any such open side may be closed by a closure member which may be locked in place to prevent accidental or unauthorised removal of a cartridge.

Preferably, the decorative surface comprises or includes advertising data. Alternatively or additionally, the decorative surface may comprise or include data to assist a traveller, e.g. the location of a customs hall.

In an alternative embodiment the entire main body, or the front portion of the main body is transparent.

The cartridge may itself comprise a multimedia device activated electronically to display an entire advertisement as opposed to a passive advertisement.

The invention will now be described by way of example with reference to the accompanying diagrammatic drawings, in which:

FIG. 1 is a side view in section of a slat constructed in accordance with the present invention;

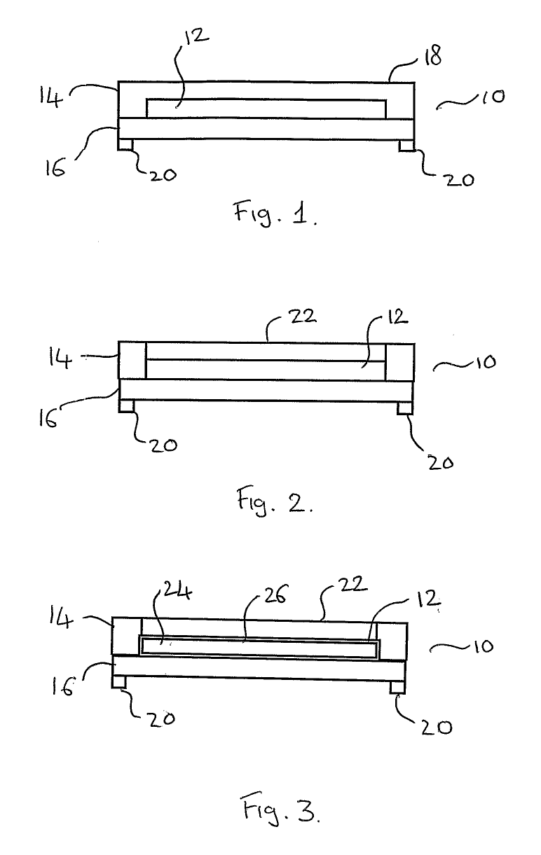

FIG. 2 is a side view in section of a slat in accordance with second embodiment of the present invention;

FIG. 3 is a side view in section of the slat of FIG. 2 incorporating a cartridge;

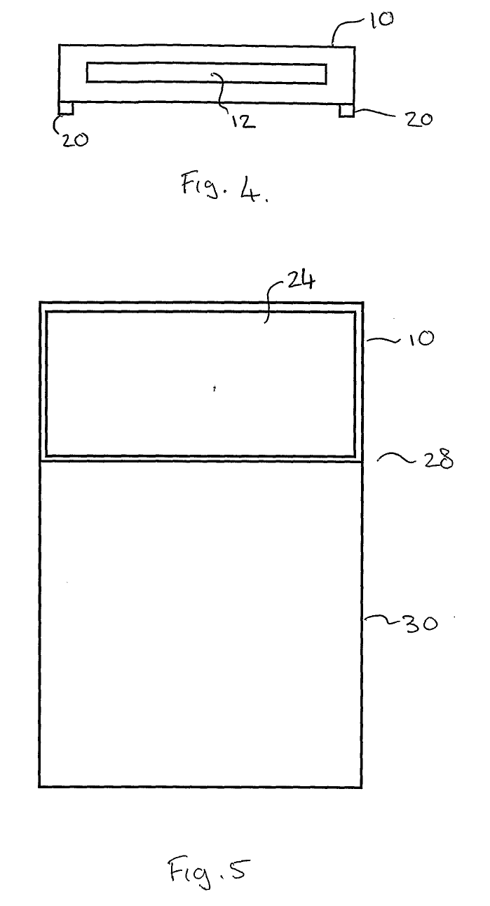

FIG. 4 is a side view in section of an alternative slat in accordance with the invention; and

FIG. 5 is a plan view of a second embodiment constructed in accordance with the present invention.

With reference to the Figures, a slat constructed in accordance with the invention comprises a main body 10 with a cavity 12 formed therein. The main body 10 comprises upper and lower portions 14, 16 which are adhered or otherwise secured together in a permanent or temporary manner. The upper portion 14 has two downwardly extending arms 18, the end surfaces of which are attached to the lower portion 16. Consequently, the cavity 12 is formed between the upper and lower portions 14, 16 when they are attached together. The cavity 12 is open at one end to receive a cartridge (to be described below). The opposite end of the cavity is closed. In an alternative arrangement, both ends of the cavity are open. Pivotable doors may be provided to close one or both open ends. These doors may be lockable to prevent inter alia unauthorised removal of a cartridge.

In a further unillustrated embodiment, a closable opening is formed in the upper and/or lower portion of the body.

The upper portion 14 is preferably made from a tempered and/or toughened glass such as that marketed under the name Plexiglass™ or similar scratch-proof glass or plastics. The upper portion 14 may, however, be constructed of other materials having the required physical characteristics of strength and abrasion resistance whereby the top surface 18 of the upper portion 12 is not unduly damaged by luggage and other items frequently being placed on and dragged against the top surface 18 of the slat or by an overlapping neighbouring slat during use of the respective carousel.

The lower portion 16 is preferably made from steel or similar material and has linking members 20 (lugs for example) attached to its underside to allow the slat to be connected to a carousel (not shown).

The upper and lower portions 14, 16 are attached together in a sealed manner to prevent dust, dirt and water from contaminating the cavity 12. To this end, silica gel may be provided within the cavity 12.

The entire upper portion 14 of the main body 10 is preferably produced from a transparent material. However, as can be seen in FIG. 2, the upper portion 14 may alternatively have a transparent window 22 formed within its upper portion.

In the embodiment illustrated in FIG. 4, the main body 10 is formed in one-piece and is not divided into upper and lower at least initially separable portions. In this case, the cavity 12 is formed in the main body 10 by, for example, extrusion or injection moulding. A steel plate with linkings may then be simply attached to the back of the main body to allow connection of the slat to a carousel.

Referring now to FIG. 3, a cartridge 24 is dimensioned so as to fit within the cavity 12 located in the main body 10 of the slat. The cartridge 24 is preferably made from a plastics material but could be produced from other materials having the required physical characteristics. At least one surface 26 of the cartridge 24 carries a decorative pattern, indicia and/or has advertising depicted thereon.

The cartridge 24 is located snugly within the cavity 12 and is removable therefrom. While within the cavity 12, the cartridge 24 may be adhered in position using a semi-permanent bond to avoid the cartridge 24 from accidentally falling out of the cavity 12 or being removed during use. Many other methods can be used to hold the cartridge within the slot during use.

In an alternative unillustrated embodiment the bottom surface of the cavity 12 is inclined downwardly. In this case, the bottom surface of the cartridge is similarly inclined to coincide with the slope of the cavity 12. Any shape of cavity may be provided, the selected shape being dependent inter alia on the shape and dimensions of the cartridge to be inserted.

In use, the cartridge 24 is positioned within the cavity 12 in such a way as to ensure that the decorative surface 26 of the cartridge 24 is visible through the transparent part 22 of the upper portion 14 of the main body 10, whereby the material of the main body 10, and particularly the upper portion 14, provides a protective cover for the cartridge 24.

In this way, the advertising incorporated within the slat can be quickly and efficiently changed by simply removing the cartridge 24 from the cavity 12 and replacing it with a new cartridge 24 carrying the appropriate advertisement. Advertising across a selected part or the entire carousel can be displayed and replaced in this way. Plain surfaced cartridges may be provided for insertion into one or more of the slats where advertising media slats are not required.

The advertising may be permanently formed on the surface of the cartridge 24 or may be removable and interchangeable with other advertisements or decoration. The data may be presented in the form of a hologram or holograph.

FIG. 5 illustrates a further embodiment of the present invention. In this embodiment the main body 10 forms only a portion of a slat 28. The rest of the slat 28 comprises load supporting body 30 in the form of a conventional conveyor slat made, for example of a combination of steel and rubber. The main body may, for example, only form approximately 30 per cent of the overall slat 28 such that the cartridge 24 is visible only in the area of the slat 28 not usually covered by luggage during use.

The main body 10 and supporting body 30 may be pivotally attached allowing easier access to and insertion of the cartridge 24. The main body 10 may be inclined relative to the supporting body 30.

The cartridge 24 may itself comprise a multi-media device such as a flat-screen television with an integral long-life battery. The cartridge 24 may include a transponder to allow wireless remote control of the multimedia cartridge 24 such that images may be displayed and changed remotely. The multimedia cartridge 24 may also include flat panel speaker technology to provide audio presentation as well as visual presentation.

A separate compact battery pack (not shown) may be used to power the multi-media cartridge 24. The battery is preferably attached to the back of the body 30 of the slat 28 where there is sufficient space and protection against damage. Alternatively the battery may be located behind the multi-media cartridge.

The battery pack may be re-charged when a carousel incorporating one or more slats 28 is docked. A row of slats 28 may be located on a carousel in use and may have alternate multi-media and blank or printed cartridges 24.

Alternatively, or additionally, the slat may include a device capable of reading data present on, for example, a luggage tag or of responding to a transponder forming part of such a tag or secured to an item of luggage. In this way, for example, a waiting passenger could be alerted via a visual display on or close to the respective carousel that his or her luggage items are about to be or are already on a particular carousel.

The cavity 12 and cartridge 24 are described herein as being rectangular in cross-section. It is, however, clearly envisaged that the cavity 12 and cartridge 24 could be of any shape provided that they are able to interrelate together as described.

The above described embodiment has been given by way of example only, and the skilled reader will naturally appreciate that many variations could be made thereto without departing from the scope of the present invention as set out in the appended claims.

1. A slat for inter alia a conveyor, the slat comprising a main body having an upper surface at least part of which is transparent and which includes a cavity positioned below the transparent surface for retaining a removable cartridge.

2. A slat according to claim 1, wherein at least one surface of the cartridge carries a decorative pattern and/or indicia.

3. A slat according to claim 2, wherein the decorative pattern and/or indicia is in the form of advertising data.

4. A slat according to claim 1, wherein the cavity is defined between at least part of the upper surface of the main body and at least part of the lower surface thereof.

5. A slat according to claim 1, wherein one or both ends of the cavity is/are opened to facilitate insertion and removal of the cartridge.

6. A slat according to claim 1, further comprising means for retaining the cartridge securely within the cavity.

7. A slat according to claim 1, wherein the transparent surface is made from tempered glass.

8. A slat as claimed in claim 1 wherein the transparent surface of the slat is scratch resistant.

9. A slat according to claim 1, wherein the upper surface further comprises a load supporting protective surface.

10. A slat according to claim 1, wherein the cartridge comprises a multi-media device.

11. A slat according to claim 10, wherein the slat comprises a computerised display screen.

12. A slat according to claim 10, further comprising electronic means to communicate data to the cartridge thereby to remotely control and change the data displayed thereon at any given point in time.

13. A slat according claim 12, wherein the electronic means is attached to the underside of the load supporting surface thereby to be protected from articles being placed on the surface in use.

14. An endless conveyor having at least one slat in accordance with claim 1.
